(19) United States
(12) Patent Application Publication
(10) Pub. No.: US 2010/0092825 A1
(43) Pub. Date: Apr. 15, 2010

(54) Fuel cell, fuel cell system, and portable electronic device

(76) Inventor: Koichi Mori, Tokyo (JP)

Correspondence Address: POSZ LAW GROUP, PLC, 12040 SOUTH LAKES DRIVE, SUITE 101, RESTON, VA, 20191, US

(21) Appl. No.: 12/311,703

(22) PCT Filed: Oct. 9, 2007
(86) PCT No.: PCT/JP2007/069688

§ 371 Date: Dec. 3, 2009

(30) Foreign Application Priority Data
Oct. 11, 2006 (JP) 2006-278170

(51) Int. Cl. H01M 8/10

(52) U.S. Cl. 429/30

(57) ABSTRACT

There is provided a fuel cell and a fuel cell system with superior power generating capability, with which the occurrence of cross-over can be suppressed and enough fuel to generate power can be fed. A fuel cell is obtained by bringing a solid fuel for a fuel cell or a gelled fuel for a fuel cell into contact with a fuel electrode. By forming the fuel for the fuel cell in a solid state or a gel state, the fuel for the fuel cell is non-fluid and can be accumulated at the fuel electrode, the fuel for the fuel cell does not penetrate an electrolyte membrane, and the occurrence of cross-over can be suppressed. Also, because the surface of the solid fuel for the fuel cell or gelled fuel for fuel cell is in a fuel atmosphere of extremely high concentration, the fuel for the fuel cell required for power generation can be adequately fed to the fuel electrode.

### TECHNICAL FIELD

This invention relates to a fuel cell, a fuel cell system, and a portable electronic device.

### BACKGROUND ART

Dealing with environmental problems and conserving our natural resources have become very important in recent years, and as a way to accomplish these goals, there has been active development of fuel cells capable of generating power by the direct feeding of water and an organic solvent serving as a liquid fuel.

In particular, direct methanol fuel cells, in which methanol is used as the liquid fuel and the methanol is fed for power generation directly, without being reformed or gasified, have a simple structure that can be miniaturized and made lightweight. Direct methanol fuel cells, therefore, hold promise as portable power supplies, as a form of distributed power supplies and as consumer power supplies in, for instance, small portable electronic devices, computers and the like.

These fuel cells that generate power by the direct feeding of a liquid fuel have basically the same configuration as polymer electrolyte fuel cells in that a membrane-electrode assembly (MEA), in which an air electrode (cathode) and a fuel electrode (anode) are bonded via electrolyte comprised a solid polymer electrolyte membrane that has proton conductivity, is supported by a separator on the air electrode side and another separator on the fuel electrode side, and a plurality of the resulting cells are stacked.

With a direct methanol fuel cell, as shown in the following Formulas (1) to (3), when a methanol aqueous solution is fed to the fuel electrode (anode) side and air, as an oxidant gas, is fed to the air electrode (cathode) side, the methanol and water react at the fuel electrode, generating carbon dioxide and releasing hydrogen ions and electrons, while at the air electrode, the oxygen in the air takes up the hydrogen ions and that pass through the electrolyte to form water and generate an electromotive force in an external circuit. The generated water is discharged from the air electrode side along with any air that did not participate in the reaction, and the generated carbon dioxide is discharged from the fuel electrode side along with any methanol aqueous solution that did not participate in the reaction.

(fuel electrode): CH₃OH+H₂0→CO₂+6H⁺+6e⁻ (1)

(air electrode): 6H⁺+ 3/2O₂+6e⁻→3H₂O (2)

(total reaction): CH₃OH+ 3/2O₂→CO₂+2H₂O (3)

This direct methanol fuel cell has almost the same standard electrode potential as hydrogen, so theoretically its power generating performance should be the same as a polymer electrolyte fuel cell (PEFC) in which hydrogen is used, but a problem is that the power generating performance drops below the theoretical value due to a phenomenon known as cross-over, in which part of the methanol escapes to the air electrode side when the methanol and water are fed to the fuel electrode in a liquid state. In view of this, a method for suppressing the occurrence of cross-over has been proposed, in which, rather than feeding the methanol in a liquid state, it is vaporized and fed to the fuel electrode side (Patent documents 1, 2).

Patent Document 1: Japanese Patent No. 3413111

Patent Document 2: Japanese Patent Application Laid-Open No. 2006-54082

### DISCLOSURE OF THE INVENTION

### Problem to be Solved by the Invention

Nevertheless, although the vaporized feeding type of fuel cells disclosed in the above-mentioned Patent Documents 1 and 2 are superior to a liquid feeding type of fuel cell in terms of suppressing the occurrence of cross-over, they are incapable of feeding enough water or fuel for power generation, so a problem is that the power generation performance is inferior to that of the liquid feeding type of fuel cell.

In view of this, it is an object of the present invention to provide a fuel cell and a fuel cell system with superior power generating capability, with which the occurrence of cross-over can be suppressed and enough fuel to generate power can be fed.

### Means for Solving the Problem

To solve the above problems, the present invention provides a fuel cell wherein a solid fuel for the fuel cell or a gelled fuel for the fuel cell is brought into contact with a fuel electrode (Invention 1). According to this invention (Invention 1), by forming the fuel for the fuel cell in a solid state or a gel state, the fuel for the fuel cell becomes non-fluid and can be accumulated at the fuel electrode, the fuel for the fuel cell will not penetrate the electrolyte membrane as happens with a liquid feeding type of fuel cell, and the occurrence of cross-over can be suppressed. Also, because the surface of the solid fuel for the fuel cell or gelled fuel for the fuel cell is in a fuel atmosphere of extremely high concentration, the fuel for the fuel cell required for power generation can be adequately fed to the fuel electrode, without running out of fuel as happens with a vaporized feed type of fuel cell in which the vaporized fuel is controlled in bulk.

In the above-mentioned invention (Invention 1), the solid fuel for the fuel cell is preferably a porous material that holds a fuel for the fuel cell (Invention 2). A porous material can take the fuel for the fuel cell into its pores easily, merely by coming into contact with the fuel for the fuel cell, so with this invention (Invention 2), the fuel for the fuel cell can be easily put in solid form, and this solid fuel for the fuel cell can be easily brought into contact with the fuel electrode.

In the present invention, the term “porous material” is a collective name for materials having a concavo-convex surface and having pores such that the depth of the concave parts is greater than the pore diameter, and refers to materials capable of taking a liquid or gaseous substance into its pores.

In the above-mentioned invention (Invention 2), it is preferable if the specific surface area of the porous material is not less than 100 m²/g (Invention 3). The amount of fuel for a fuel cell that is taken into the pores of the porous material depends generally on the specific surface area of the porous material, and when the energy density per unit of volume is taken into account, the greater is the specific surface area, the better, and with this invention (Invention 3), the fuel for the fuel cell required for power generation can be adequately fed to the fuel electrode.

In the above-mentioned invention (Invention 1), it is preferable if the solid fuel for the fuel cell is a molecular compound into which a fuel for a fuel cell has been introduced (Invention 4). In this invention (Invention 4), it is preferable if the molecular compound is an inclusion compound in which a fuel for a fuel cell has been enclosed as a guest molecule in a host molecule (Invention 5).

Since the solid fuel for the fuel cell can be obtained by bringing the fuel for the fuel cell into contact with the molecular compound, with the above-mentioned inventions (Inventions 4 and 5), the solid fuel for the fuel cell can be brought into contact with the fuel electrode and the fuel for the fuel cell required for power generation can be adequately fed to the fuel electrode.

The term “inclusion compound” used in the present invention means a compound with which ions, atoms, molecules, or the like can be introduced into cavities within molecules or molecular assemblies through a variety of interactions. With an inclusion compound, the substance that takes in the ions, atoms, molecules, or the like is called the host molecule, while the substance taken in by the host molecule is called the guest molecule.

In the above-mentioned invention (Invention 5), it is preferable if the host molecule is a polymolecular compound (Invention 6). The inclusion power of a polymolecular compound serving as the host molecule is not greatly affected by the size of the guest molecule, so with this invention (Invention 6), it is easy to obtain a solid fuel for a fuel cell in which a fuel for a fuel cell is enclosed in a polymolecular compound serving as the host molecule, and the fuel for the fuel cell required for power generation can be adequately fed to the fuel electrode.

In the above-mentioned invention (Invention 1), it is preferable if the gelled fuel for the fuel cell includes a fuel for a fuel cell and a gelling agent, and is obtained by turning the fuel for the fuel cell into a gel (Invention 7). Since the gelled fuel for the fuel cell is obtained by bringing the fuel for the fuel cell and the gelling agent into contact, with this invention (Invention 7), the gelled fuel for the fuel cell can be easily brought into contact with the fuel electrode, the gelled fuel for the fuel cell can be accumulated at the fuel electrode, and the fuel for the fuel cell required for power generation can be adequately fed to the fuel electrode.

The term “gelling agent” used in the present invention means a compound with which self-associate with non-covalent bonds such as hydrogen bonds to form fibrous associations when dissolved in the fuel for the fuel cell, and these become bundles that are intertwined in a net shape, and ultimately form a three-dimensional net structure, which can take in and gel the fuel for the fuel cell.

With the above-mentioned invention (Invention 7), it is preferable if the gelling agent is a low-molecular weight organic compound with a molecular weight of 10,000 or less (Invention 8). An organic compound with a molecular weight of 10,000 or less can gel the fuel for the fuel cell merely by being added in a minute amount to the fuel for the fuel cell, so with this invention (Invention 8), a gelled fuel for a fuel cell with a large content of fuel for fuel cell can be brought into contact with the fuel electrode, the gelled fuel for the fuel cell can be accumulated at the fuel electrode, and the fuel for the fuel cell required for power generation can be adequately fed to the fuel electrode.

With the above-mentioned inventions (Inventions 7 and 8), it is preferable if the gelling agent is dibenzylidene-D-sorbitol (Invention 9). Dibenzylidene-D-sorbitol can gel the fuel for the fuel cell by being added in a minute amount to the fuel for the fuel cell, so with this invention (Invention 9), the gelled fuel for the fuel cell with a large content of fuel for fuel cell can be brought into contact with the fuel electrode, the gelled fuel for the fuel cell can be accumulated at the fuel electrode, and the fuel for the fuel cell required for power generation can be adequately fed to the fuel electrode.

In the above-mentioned inventions (Inventions 7 to 9), it is preferable if the gelled fuel for the fuel cell further includes at least one member of the group consisting of cellulose derivatives, polyethylene glycol, and partially saponified polyvinyl alcohol (Invention 10).

When a cellulose derivative, polyethylene glycol, a partially saponified polyvinyl alcohol, or another such stabilizer is dissolved along with a gelling agent in the fuel for the fuel cell, the polymer chains of the stabilizer become complexly entangled with the fiber assembly formed by the gelling agent, forming a strong net structure, so with the above-mentioned invention (Invention 10), the gelled fuel for the fuel cell can be stabilized and the gelled fuel for the fuel cell can be easily brought into contact with the fuel electrode and accumulated at the fuel electrode.

With the above-mentioned invention (Invention 10), it is preferable if the cellulose derivative is hydroxypropyl cellulose (Invention 11).

With the above-mentioned inventions (Inventions 1 to 11), it is preferable if the solid fuel for the fuel cell or the gelled fuel for the fuel cell is formed into a sheet (Invention 12).

Because the surface of the solid fuel for the fuel cell or the gelled fuel for the fuel cell is in a fuel atmosphere of extremely high concentration, a large amount of fuel can be spontaneously fed to the fuel electrode by bringing the solid fuel for the fuel cell or the gelled fuel for the fuel cell into contact with the fuel electrode, but if the fuel is fed in a high concentration only locally to the fuel electrode, there will be considerable Nernst loss and the output may decrease. Accordingly, with the invention (Invention 12), the fuel can be fed more uniformly to the fuel electrode by forming the solid fuel for the fuel cell or the gelled fuel for the fuel cell as a sheet.

With the above-mentioned inventions (Inventions 1 to 12), it is preferable if the fuel for the fuel cell is an alcohol, or an alcohol and water (Invention 13). With this invention (Invention 13), it is preferable if the alcohol is methanol (Invention 14).

There is further provided a fuel cell system comprising the fuel cell according to any of the above-mentioned inventions (Inventions 1 to 14) (Invention 15). With this invention (Invention 15), cross-over can be suppressed and a fuel cell system with superior power generation performance can be provided.

There is further provided a portable electronic device which is driven by electricity generated by the fuel cell system according to the above-mentioned invention (Invention 15) (Invention 16).

### ADVANTAGEOUS EFFECT OF THE INVENTION

The present invention provides a fuel cell and a fuel cell system with superior power generation performance, with which cross-over can be suppressed and the fuel required for power generation can be adequately fed.

### BRIEF DESCRIPTION OF THE DRAWINGS

FIG. 1 is a simplified diagram illustrating a fuel cell system (1) pertaining to an embodiment of the present invention;

FIG. 2 is a simplified diagram illustrating a fuel cell system (2) pertaining to an embodiment of the present invention;

FIG. 3 is a simplified diagram illustrating a fuel cell system (3) pertaining to an embodiment of the present invention; and

FIG. 4 is a graph of the results of measuring the current-voltage curve in Example 1, Example 2, Comparative Example 1, and Comparative Example 2.

### EXPLANATION OF REFERENCE NUMERALS

1 . . . fuel cell
2 . . . fuel electrode
5 . . . solid fuel for fuel cell
6 . . . gelled fuel for fuel cell
10 . . . fuel cell system

### BEST MODE FOR CARRYING OUT THE INVENTION

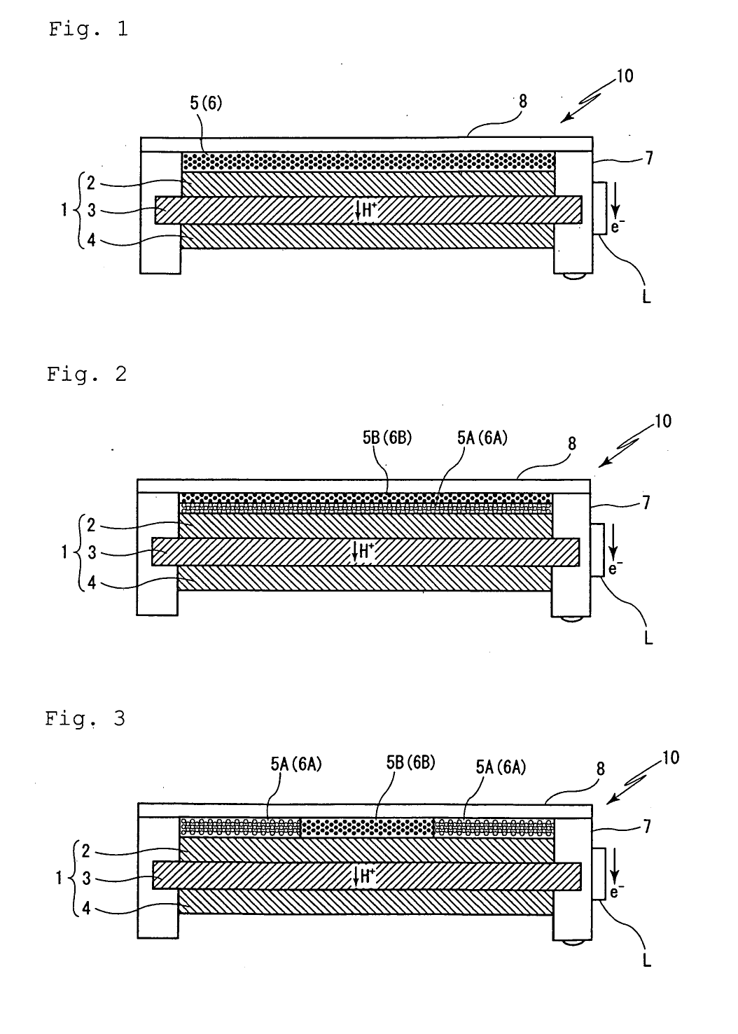

The fuel cell system pertaining to an embodiment of the present invention will now be described. As shown in FIG. 1, the fuel cell system 10 pertaining to this embodiment comprises a fuel cell 1 having a fuel electrode 2, an electrolyte membrane 3, and an air electrode 4. A solid fuel for a fuel cell 5, obtained by putting a fuel for a fuel cell in solid form, or a gelled fuel for a fuel cell 6, obtained by putting a fuel for a fuel cell in gelled form, is brought into contact with the fuel electrode 2 in this system.

The fuel electrode 2 and the air electrode 4 are electrically connected by an electrical circuit L. The fuel cell 1 and the solid fuel for the fuel cell 5 or gelled fuel for fuel cell 6 are fixed to a frame 7 so as to be surround on all four sides, and the top is covered by a cover 8 that can be opened and closed.

The solid fuel for the fuel cell 5 is, for example, the product of holding a fuel for a fuel cell held on a porous material, the product of introducing a fuel for a fuel cell in a molecular compound, or the like, but is not limited to these examples.

Examples of the fuel for the fuel cell include alcohols, ethers, hydrocarbons, acetals, and formic acids, but this list is not intended to be comprehensive. More specifically, the fuel for the fuel cell can be methanol, ethanol, a modified alcohol, 1-propanol, 2-propanol, 1-butanol, 2-butanol, tert-butanol, ethylene glycol, or another such lower aliphatic alcohol with 1 to 4 carbons; dimethyl ether, methyl ethyl ether, diethyl ether, or another such ether; propane, butane, or another such hydrocarbon; dimethoxymethane, trimethoxymethane, or another such acetal; or formic acid, methyl formate, or another such formic acid. These may be used singly or as mixtures of two or more. Of these, it is preferable to use methanol, which is the fuel in a direct methanol fuel cell.

The porous material has a concavo-convex surface, and has pores such that the depth of the concave parts is greater than the pore diameter. There are no particular restrictions on the pore diameter of the porous material as long as the fuel for the fuel cell components can fit into the pores and can be held within these pores, and examples include ultramicropores with a pore diameter of less than 0.5 nm, micropores with a pore diameter of at least 0.5 nm and less than 2 nm, mesopores with a pore diameter of at least 2 nm and less than 50 nm, and macropores with a pore diameter of at least 50 nm. As long as the pores have diameters such as these, the fuel for the fuel cell can be effectively held.

The amount of fuel for fuel cell that can be held in the pores of the porous material is depended on the specific surface area of the porous material, so when the energy density per unit of volume is taken into account, the greater is the specific surface area, the better. More specifically, the specific surface area of the porous material is preferably from 100 to 1500 m²/g, and more preferably 200 to 1500 m²/g, and the bulk specific volume (tap) of the porous material is preferably from 2.0 to 20 mL/g.

Examples of the form of the porous material include a powder, particles, fibers, a film, and pellets. The raw material on which the porous material is based can be an organic material, an inorganic material, or a composite of these.

Examples of this porous material include silica gel, powdered silica, zeolites, activated alumina, magnesium aluminate metasilicate, activated charcoal, a molecular sieve, carbon, carbon fiber, activated clay, bone black, porous glass; micropowders composed of anodized aluminum, titanium oxide, calcium oxide, and other such inorganic oxides; calcium titanate, sodium niobate, and other such perovskite oxide minerals; sepiolite, kaolinite, montmorillonite, saponite, and other such clay minerals; and ion exchange resins and other such synthetic adsorptive resins. These porous materials may be used singly or as mixtures of two more.

Of these porous materials, the use of magnesium aluminate metasilicate is preferred. Because the bulk specific volume of magnesium aluminate metasilicate can be reduced by using the appropriate manufacturing method, this material is favorable for use in products that need to be more compact, such as direct methanol fuel cells. Also, magnesium aluminate metasilicate is a material used as a raw material for gastric preparations, and is acknowledged to be safe to humans, so it can be used favorably.

There are no particular restrictions on the method for holding the fuel for the fuel cell on the porous material, but the solid fuel for the fuel cell 5 in which the fuel for the fuel cell is supported in the porous material can be manufactured, for example, by adding the fuel for the fuel cell to the porous material and thoroughly stirring.

The amount of porous material used in this case is preferably 0.2 to 1 weight part per weight part of fuel for fuel cell. If the amount of porous material is within the above range, the fuel for the fuel cell can be effectively held by the porous material, and the solid fuel for the fuel cell 5 obtained by holding the fuel for the fuel cell in the porous material can be effectively formed.

There are no particular restrictions on the temperature and pressure conditions under which the fuel for the fuel cell held in the porous material, and the fuel for the fuel cell may be held in the porous material at normal temperature and pressure. The solid fuel for the fuel cell 5 in which the fuel for the fuel cell is held in the porous material can be manufactured by mixing the fuel for the fuel cell and the porous material at normal temperature and pressure and thoroughly stirring. If a gaseous fuel is used as the fuel for the fuel cell, the fuel for the fuel cell is preferably held in the porous material under pressurization.

The molecular compound is a compound that can be bonded to the fuel for the fuel cell by relatively weak interaction other than covalent bonds typified by Van der Waal's force and hydrogen bonds, and includes hydrates, solvates, addition compounds, inclusion compounds, and so forth. This molecular compound can be formed by a contact reaction between the fuel for the fuel cell and the compound that forms the molecular compound, a gas or liquid fuel for fuel cell can be changed into a solid compound, and the fuel for the fuel cell can be stored stably in a relatively small amount.

An inclusion compound capable of enclosing the fuel for the fuel cell by reaction between the host compound and the fuel for the fuel cell serving as the guest compound is preferable as the molecular compound in this embodiment.

Known host compounds that form an inclusion compound in which a fuel for a fuel cell is enclosed are those composed of organic compounds, inorganic compounds, and organic-inorganic composite compounds, and known organic compounds are monomolecular host compounds, polymolecular host compounds, macromolecular host compounds, and so forth.

Almost all monomolecular host compounds are large cyclic compounds. These compounds can enclose in their rings ions or organic substances corresponding to the electrical atmosphere or the size thereof, individually and in solution. Examples of such host compounds include cyclodextrin, crown ether, cryptand, cyclophane, azacyclophane, calixarene, cyclotriveratrylene, spherand, and cyclic oligopeptide.

A polymolecular host compound encloses the guest not individually, but in the form of a molecular assembly (mainly crystals). Examples of polymolecular host compounds include urea, 1,1,6,6-tetraphenylhexa-2,4-diyne-1,6-diol, 1,1-bis(2,4-dimethylphenyl)-2-propyne-1-ol, 1,1,4,4-tetraphenyl-2-butyne-1,4-diol, 1,1,6,6-tetrakis(2,4-dimethylphenyl)-2,4-hexadiyne-1,6-diol, 9,10-diphenyl-9,10-dihydroanthracene-9,10-diol, 9,10-bis(4-methylphenyl)-9,10-dihydroanthracene-9,10-diol, 1,1,2,2-tetraphenylethane-1,2-diol, 4-methoxyphenol, 2,4-dihydroxybenzophenone, 4,4′-dihydroxybenzophenone, 2,2′-dihydroxybenzophenone, 2,2′,4,4′-tetrahydroxybenzophenone, 1,1-bis(4-hydroxyphenyl)cyclohexane, 4,4′-sulfonylbisphenol, 2,2′-methylenebis(4-methyl-6-t-butylphenol), 4,4′-ethylidenebisphenol, 4,4′-thiobis(3-methyl-6-t-butylphenol), 1,1,3-tris(2-methyl-4-hydroxy-5-t-butylphenyl)butane, 1,1,2,2-tetrakis(4-hydroxyphenyl)ethane, 1,1,2,2-tetrakis(4-hydroxyphenyl)ethylene, 1,1,2,2-tetrakis(3-methyl-4-hydroxyphenyl)ethane, 1,1,2,2-tetrakis(3-fluoro-4-hydroxyphenyl)ethane, α,α,α′,α′-tetrakis(4-hydroxyphenyl)-p-xylene, tetrakis(p-methoxyphenyl)ethylene, 3,6,3′,6′-tetramethoxy-9,9′-bi-9H-xanthene, 3,6,3′,6′-tetraacetoxy-9,9′-bi-9H-xanthene, 3,6,3′,6′-tetrahydroxy-9,9′-bi-9H-xanthene, gallic acid, methyl gallate, catechin, bis-β-naphthol, α,α,α′, α′-tetraphenyl-1,1′-biphenyl-2,2′-dimethanol, bisdicyclohexylamide diphenate, bisdicyclohexylamide fumarate, cholic acid, deoxycholic acid, 1,1,2,2-tetraphenylethane, tetrakis(p-iodophenyl)ethylene, 9,9′-bianthryl, 1,1,2,2-tetrakis(4-carboxyphenyl)ethane, 1,1,2,2-tetrakis(3-carboxyphenyl)ethane, acetylenedicarboxylic acid, 2,4,5-triphenylimidazole, 1,2,4,5-tetraphenylimidazole, 2-phenylphenanthro[9,10-d]imidazole, 2-(o-cyanophenyl)phenanthro[9,10-d]imidazole, 2-(m-cyanophenyl)phenanthro[9,10-d]imidazole, 2-(p-cyanophenyl)phenanthro[9,10-d]imidazole, hydroquinone, 2-t-butylhydroquinone, 2,5-di-t-butylhydroquinone, and 2,5-bis(2,4-dimethylphenyl)hydroquinone.

Examples of macromolecular host compounds include cellulose, starch, chitin, chitosan, polyvinyl alcohol, a polyethylene glycol arm polymer having 1,1,2,2-tetrakisphenylethane as its core, and a polyethylene glycol arm polymer having α,α,α′,α′-tetrakisphenylxylene as its core. Additional examples include organophosphorus compounds and organosilicon compounds.

Examples of inorganic host compounds include titanium oxide, graphite, alumina, transition-metal dichalcogenite, lanthanum fluoride, clay minerals (montmorillonite, etc.), silver salts, silicates, phosphates, zeolites, silica, and porous glass.

Of these, it is preferable to use as the host compound a polymolecular host compound in which the inclusion capability is not greatly affected by the size of the molecule of a guest compound. Among polymolecular host compounds, advantageous in terms of inclusion capability are phenolic host compounds such as 1,1-bis(4-hydroxyphenyl)cyclohexane, 1,1,2,2-tetrakis(4-hydroxyphenyl)ethane, and 1,1,2,2-tetrakis(4-hydroxyphenyl)ethylene; amidic host compounds such as bis(dicyclohexylamide) diphenate and bisdicyclohexylamide fumarate; and imidazolic host compounds such as 2-(m-cyanophenyl)phenanthro[9,10-d]imidazole. In particular, phenolic host compounds such as 1,1-bis(4-hydroxyphenyl)cyclohexane are advantageous because they are easier to use in an industrial setting.

An example of how to synthesize the inclusion compound of the fuel for the fuel cell using a host compound such as 1,1-bis(4-hydroxyphenyl)cyclohexane is a method in which the fuel for the fuel cell and the host compound are mixed and brought into direct contact with each other. An inclusion compound enclosing the fuel for the fuel cell can be easily synthesized in this way. An inclusion compound can also be synthesized by dissolving the host compound in the fuel for the fuel cell under heating or the like and then recrystallizing.

There are no particular restrictions on the temperature at which the fuel for the fuel cell and the host compound are brought into contact for the synthesis of the inclusion compound, but it is preferably between room temperature and about 100° C. Nor are there any particular restrictions on the pressure at this point, but conducting the process under normal pressure is preferable. There are no particular restrictions on how long the fuel for the fuel cell and the host compound are in contact with each other, but it is preferably about 0.01 to 24 hours in terms of working efficiency.

The inclusion compound obtained in this way will vary with the type of host compound used, the conditions of contact with the fuel for the fuel cell, and so forth, but is usually an inclusion compound which encloses 0.1 to 10 mol of organic fuel molecules per mole of the host compound.

The gelled fuel for the fuel cell 6 is obtained by adding a low-molecular weight organic gelling agent to the fuel for the fuel cell, and gelling.

The low-molecular weight organic gelling agent is an organic compound with a molecular weight of 10,000 or lower, which when added to the fuel for the fuel cell, made into a uniform solution by being dissolved under thermal or other energy, for example, and allowed to stand, forms fibrous assemblies with two-dimensional orientation, and these become entangled to form a three-dimensional net structure, into which the fuel for the fuel cell is introduced, thereby gelling the fuel for the fuel cell.

Examples of this low-molecular weight organic gelling agent include dibenzylidene-D-sorbitol, methylbenzylidene-D-galactose, isopropylidene glyceraldehyde derivatives, 12-hydroxystearic acid, N-lauroyl-L-glutamic acid-α,γ-bis-n-butyramide, spin-labeled steroids, cholesterol derivatives, aluminum dialkylphosphates, phenolic cyclic oligomers, 2,3-bis-n-hexadecyloxyanthrocene, cyclic depsipeptides, partially fluorinated alkanes, cysteine derivatives, sodium bis(2-ethylhexyl)sulfosuccinate, triphenylamine derivatives, butyrolactone derivatives, quaternary ammonium salts, fluorinated alkylated oligomers, urea derivatives, vitamin H derivatives, gluconamide derivatives, cholic acid derivatives, L-isoleucine derivatives, L-valine derivatives, cyclic dipeptide derivatives, diamides, urea derivatives, and other such cyclohexanediamine derivatives. These low-molecular weight organic gelling agents can be used singly or as mixtures of two or more.

Of these low-molecular weight organic gelling agents, dibenzylidene-D-sorbitol is preferred. Dibenzylidene-D-sorbitol can gel the fuel for the fuel cell when added in only a tiny amount. More specifically, 0.01 to 0.1 weight part of dibenzylidene-D-sorbitol may be added per weight part of fuel for fuel cell. If dibenzylidene-D-sorbitol is used to gel the fuel for the fuel cell, a gelled fuel for a fuel cell with an extremely high proportion of fuel for fuel cell can be obtained, which is advantageous in terms of energy density when the gelled fuel for the fuel cell is used to drive a fuel cell system.

However, the gelling motive power provided by the low-molecular weight organic gelling agent is a relatively weak, non-covalent bond type of force typified by a hydrogen bond, a Van der Waal's force, a π-π interaction, an electrostatic interaction, or the like, so when the fuel for the fuel cell is gelled by a low-molecular weight organic gelling agent, if the gelled fuel for the fuel cell thus obtained is left standing for an extended period or is subjected to a powerful external force, there is the risk that the fibrous assemblies that make up the gel will be destroyed and solid-liquid phase separation or other such damage will occur.

In view of this, to solve these problems, it is preferable if at least one member of a cellulose derivative, polyethylene glycol, and partially saponified polyvinyl alcohol is added in a tiny amount as a stabilizer of the gelled fuel for the fuel cell to the fuel for the fuel cell. If these stabilizers are dissolved along with a low-molecular weight organic gelling agent in the fuel for the fuel cell, the polymer chains of the stabilizer will become complexly entangled with the fibrous assemblies formed by the low-molecular weight organic gelling agent, forming a stronger three-dimensional net structure, and allowing a more stable gelled fuel for fuel cell to be obtained.

A completely saponified polyvinyl alcohol is insoluble in alcohols and other such fuels for fuel cell, so when a polyvinyl alcohol is used as a stabilizer, it is preferable to use a partially saponified polyvinyl alcohol, and it is particularly favorable to use a partially saponified polyvinyl alcohol whose degree of saponification is no more than 70.

A cellulose derivative is preferably used as this stabilizer, and the use of hydroxypropyl cellulose is particularly favorable.

This stabilizer may be added in a tiny amount to the fuel for the fuel cell, and more specifically, the stabilizer may be added in an amount of about 0.001 to 0.05 weight part per weight part of fuel for fuel cell.

As to the method for gelling the fuel for the fuel cell, a low-molecular weight organic gelling agent and a stabilizer (if needed) may be added to and dissolved in the fuel for the fuel cell, with no restrictions on the order in which they are added or how they are dissolved. For instance, a low-molecular weight organic gelling agent and a stabilizer may be added to the fuel for the fuel cell and the system thoroughly stirred under heating, which dissolves the low-molecular weight organic gelling agent and the stabilizer in the fuel for the fuel cell. After this, the system is allowed to stand at room temperature, during which time gelling will proceed gradually, with the gelling being complete and a gelled fuel for a fuel cell obtained after the system has stood at room temperature for about 0.01 to 24 hours.

The gelled fuel for the fuel cell obtained in this manner preferably contains less than 10 wt % stabilizer and low-molecular weight organic gelling agent. If the low-molecular weight organic gelling agent and stabilizer content is within the above range, this means that the fuel for the fuel cell content will be over 90 wt %, so the product can be used as a gelled fuel for a fuel cell whose energy density per unit of volume is on a par with that of the raw material methanol.

The solid fuel for the fuel cell 5 or gelled fuel for fuel cell 6 thus obtained is arranged so as to come into contact with the fuel electrode 2 of the fuel cell 1. Consequently, the fuel required for power generation can be adequately fed to the fuel electrode, and cross-over can also be suppressed.

The solid fuel for the fuel cell 5 and the gelled fuel for the fuel cell 6 can be in any form, such as a powder, particles, pellets, fibers, or a sheet, but a sheet is preferable. The surface of the solid fuel for the fuel cell 5 or the gelled fuel for the fuel cell 6 is in a fuel atmosphere of extremely high concentration, a large amount of fuel for fuel cell can be spontaneously fed to the fuel electrode, and if the amount in which the fuel for the fuel cell is fed to the fuel electrode is uneven, there will be considerable Nernst loss and the output may decrease. Therefore, the fuel for the fuel cell fed to the fuel electrode is preferably fed uniformly to all portions of the fuel electrode, and putting the solid fuel for the fuel cell 5 or gelled fuel for fuel cell 6 in the form of a sheet is a favorable way to accomplish this.

There are no particular restrictions on the method for forming the solid fuel for the fuel cell 5 as a sheet, but for example, with a solid fuel for a fuel cell in which the fuel for the fuel cell is held in the porous material, or a solid fuel for a fuel cell in which the fuel for the fuel cell is enclosed in a host molecule, since the resulting solid fuel for fuel cell will usually be in the form of a powder or particles, one method that can be used is to subject a fuel for fuel cell in the form of a powder or particles to compression molding using a binder or the like.

Because the fuel for the fuel cell used in a direct methanol fuel cell is methanol and/or a methanol aqueous solution, methanol is preferable as the binder used for forming the solid fuel for the fuel cell, and it is also preferable to use the methanol along with a substance that has the property of thickening upon contact with methanol and that contributes to the binding of the particles together through this thickening action.

Examples of binders having the property of thickening upon contact with methanol and/or a methanol aqueous solution include methyl cellulose, ethyl cellulose, hydroxyethyl cellulose, hydroxypropyl cellulose, hydroxypropyl methyl cellulose, hydroxyethyl methyl cellulose, hydroxypropyl methyl cellulose acetate succinate, and other such cellulose derivatives; aminoalkyl methacrylate copolymers, methacrylic acid copolymers, ethyl acrylate-methyl methacrylate copolymers, and other such acrylic acid-based polymers; polyvinyl alcohol (PVA), and other such water-soluble polymers; polyvinylpyrrolidone (PVP) and other such water and alcohol-soluble polymers; and starch, cornstarch, molasses, lactose, cellulose, gelatin, dextrin, gum arabic, and other such saccharide compounds. These may be used singly or in mixtures of two or more.

When methanol is used as the binder, the step of introducing the methanol that is the fuel for the fuel cell into the porous material or host molecule may be omitted. In this case, the methanol that is the fuel for the fuel cell can be introduced into the porous material or host molecule while the solid fuel for the fuel cell 5 is formed by adding the methanol as a binder to the porous material or host molecule.

When methanol and a cellulose derivative or PVP are used together as the binder, the ratio (by weight) in which the methanol and the cellulose derivative or PVP are contained in the binder is preferably 1000:1 to 10:1. It will be possible to form the solid fuel for the fuel cell 5 effectively as long as the ratio is within this range.

An example of a method for using a binder to form the solid fuel for the fuel cell 5 is a method in which the porous material, the methanol, and the cellulose derivative are brought into contact to produce a viscous fluid, which is used to fill a mold of the appropriate size and subjected to compression molding.

One way to form the gelled fuel for the fuel cell 6 as a sheet, for example, is to add a gelling agent and, as needed, a stabilizer to the fuel for the fuel cell, heat or stir as necessary to dissolve the gelling agent and stabilizer in the fuel for the fuel cell, pour this solution into a mold of the appropriate size, and allow to cool to obtain a gelled fuel for a fuel cell 6 in the form of a sheet.

The solid fuel for the fuel cell 5 or gelled fuel for fuel cell 6 thus formed as a sheet can itself generate power by coming into contact with the fuel electrode 2, but when the fuel for the fuel cell is a methanol aqueous solution, for example, more methanol than water is emanated from the surface of the solid fuel for the fuel cell 5 or gelled fuel for fuel cell 6, and in view of the fact that methanol and water undergo an equimolar reaction at the fuel electrode 2, there is the risk that too much methanol will be fed to the fuel electrode 2.

With this in mind, as shown in FIG. 2, the sheet-form solid fuel for fuel cell 5 or gelled fuel for fuel cell 6 is preferably given a two-layer structure that allows the balance of methanol and water held to be adjusted. More specifically, it is preferable if water (or a methanol aqueous solution) is used for a first layer comprising a first solid fuel for fuel cell 5A or a first gelled fuel for fuel cell 6A, methanol is used for a second layer comprising a second solid fuel for fuel cell 5B or a second gelled fuel for fuel cell 6B, the first solid fuel for fuel cell 5A or the first gelled fuel for fuel cell 6A is brought into contact with the fuel electrode 2, and the second solid fuel for fuel cell 5B or the second gelled fuel for fuel cell 6B is laminated over the first solid fuel for fuel cell 5A or the first gelled fuel for fuel cell 6A.

If a methanol aqueous solution is held as the fuel for the fuel cell in the first solid fuel for fuel cell 5A or first gelled fuel for fuel cell 6A, there are no particular restrictions on the concentration of methanol, but 0 to 50 wt % is preferable.

The first solid fuel for fuel cell 5A and second solid fuel for fuel cell 5B may be produced by holding a fuel for a fuel cell in a porous material, or by introducing a fuel for a fuel cell into a host molecule, or by a combination of these.

The solid fuel for the fuel cell 5 and the gelled fuel for the fuel cell 6 may also be combined and laminated to the fuel electrode 2. In this case, the solid fuel for the fuel cell 5 may be brought into contact with the fuel electrode 2, or the gelled fuel for the fuel cell 6 may be brought into contact with the fuel electrode 2.

For example, a solid fuel for a fuel cell 5 produced by holding a fuel for a fuel cell in a porous material such as powdered silica or magnesium metasilicate aluminate with a high water retention capacity may be brought into contact with the fuel electrode 2, and a gelled fuel for a fuel cell 6 produced by adding dibenzylidene-D-sorbitol to a fuel for a fuel cell and gelling may be laminated to this solid fuel for fuel cell 5.

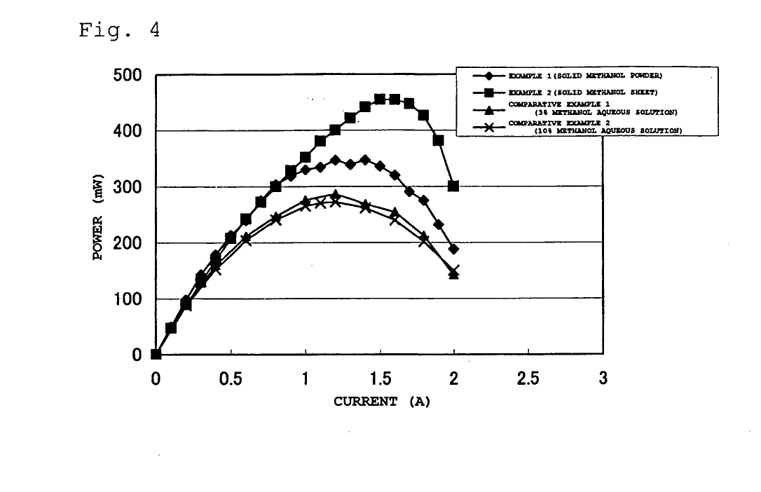

As shown in FIG. 3, for example, the solid fuel for the fuel cell 5 or gelled fuel for fuel cell 6 may be divided into three regions, so that a solid fuel for a fuel cell 5 produced by holding water or a gelled fuel for a fuel cell 6 produced by gelling water, and a solid fuel for a fuel cell 5 produced by holding a fuel for a fuel cell or a gelled fuel for a fuel cell 6 produced by gelling a fuel for a fuel cell, are brought into contact with the fuel electrode 2. In this case, the solid fuel for the fuel cell 5 produced by holding water or the gelled fuel for the fuel cell 6 produced by gelling water can be disposed in the regions at both ends, and the solid fuel for the fuel cell 5 produced by holding a fuel for a fuel cell or the gelled fuel for the fuel cell 6 produced by gelling a fuel for a fuel cell can be disposed in the region flanked by these two regions. This allows adjustment of the balance at which the fuel for the fuel cell and water are fed to the fuel electrode 2.

There are no particular restrictions on the fuel cell system 10 having the fuel cell 1 described above, but examples include a direct methanol fuel cell system, a polymer electrolyte fuel cell system, and a solid oxide fuel cell system.

This fuel cell system 10 can be used favorably as a power supply for a portable telephone, a notebook computer, a digital camera, or another such portable electronic device by electrically connecting this fuel cell system to the portable electronic device.

The embodiment described above was given to facilitate an understanding of the present invention, and not to limit the present invention. Therefore, the various elements disclosed in the embodiment should be interpreted to encompass all design modifications, equivalents, and so forth within the technological scope of the present invention.

### EXAMPLES

The present invention will now be described in detail through examples, but is in no way limited to the following examples.

These examples were conducted using the following fuel cell.

An electrode coated with a catalyst layer was thermocompression bonded to a Nafion 112 membrane (made by DuPont) to prepare a membrane-electrode assembly (MEA). The electrode surface area was 20 cm², Pt—Ru/C was used as the fuel electrode-side electrode, and Pt/C was used as the air electrode-side electrode. This MEA was incorporated into an actual fuel cell made in the laboratory, and current-voltage measurement was conducted.

An electronic load tester (PLZ164WA, a trade name of Kikusui Electronic) was used to control the current and voltage.

### Example 1

13 g of a 10 wt % methanol aqueous solution was added to 5 g of powdered magnesium aluminate metasilicate and thoroughly stirred, which gave a solid fuel in the form of a powder. 10 g of the powdered solid fuel thus obtained was brought into contact with the fuel electrode, current-voltage measurement was conducted, and the output was evaluated.

The results are given in FIG. 4.

### Example 2

14 g of a 5 wt % hydroxypropyl cellulose aqueous solution was added to 5 g of powdered magnesium aluminate metasilicate and thoroughly stirred, which gave a first solid fuel. Also, 13.5 g of methanol was added to 5 g of powdered magnesium aluminate metasilicate and thoroughly stirred, which gave a second solid fuel. 3 g of the first solid fuel was put into a mold for making a square sheet measuring 50 mm×50 mm, and the surface was leveled by shaking. After this, 3 g of the second solid fuel was put in the mold, and compression molding was performed. The solid fuel sheet thus obtained was arranged so that the first solid fuel came into contact with the fuel electrode, current-voltage measurement was conducted, and the output was evaluated.

The results are given in FIG. 4.

### Comparative Example 1

97 g of water was added to 3 g of methanol and thoroughly stirred to prepare a 3 wt % methanol aqueous solution. 8 g of the 3 wt % methanol aqueous solution thus obtained was fed to the fuel electrode, current-voltage measurement was conducted, and the output was evaluated.

The results are given in FIG. 4.

### Comparative Example 2

90 g of water was added to 10 g of methanol and thoroughly stirred to prepare a 10 wt % methanol aqueous solution. 8 g of the 10 wt % methanol aqueous solution thus obtained was fed to the fuel electrode, current-voltage measurement was conducted, and the output was evaluated.

The results are given in FIG. 4.

A shown in FIG. 4, the output from the fuel cell was highest with the solid methanol sheet in Example 2, with the powdered solid methanol of Example 1 being next, and the output was higher with both of these types of solid methanol than with a methanol aqueous solution. On the other hand, with the methanol aqueous solutions of Comparative Examples 1 and 2, no major difference in output was noted whether the concentration was 3 wt % or 10 wt %.

1. A fuel cell, wherein a solid fuel for a fuel cell or a gelled fuel for a fuel cell is brought into contact with a fuel electrode.

2. The fuel cell according to claim 1, wherein the solid fuel for the fuel cell is a porous material that holds a fuel for a fuel cell.

3. The fuel cell according to claim 2, wherein the specific surface area of the porous material is not less than 100 m²/g.

4. The fuel cell according to claim 1, wherein the solid fuel for the fuel cell is a molecular compound into which a fuel for a fuel cell has been introduced.

5. The fuel cell according to claim 4, wherein the molecular compound is an inclusion compound in which a fuel for a fuel cell has been enclosed as a guest molecule in a host molecule.

6. The fuel cell according to claim 5, wherein the host molecule is a polymolecular compound.

7. The fuel cell according to claim 1, wherein the gelled fuel for the fuel cell includes a fuel for a fuel cell and a gelling agent, and is obtained by turning the fuel for the fuel cell into a gel.

8. The fuel cell according to claim 7, wherein the gelling agent is a low-molecular weight organic compound with a molecular weight of 10,000 or less.

9. The fuel cell according to claim 7, wherein the gelling agent is dibenzylidene-D-sorbitol.

10. The fuel cell according to claim 7, wherein the gelled fuel for the fuel cell further includes at least one member of the group consisting of cellulose derivatives, polyethylene glycol, and partially saponified polyvinyl alcohol.

11. The fuel cell according to claim 10, wherein the cellulose derivative is hydroxypropyl cellulose.

12. The fuel cell according to claim 1, wherein the solid fuel for the fuel cell or the gelled fuel for the fuel cell is formed into a sheet.

13. The fuel cell according to claim 1, wherein the fuel for the fuel cell is an alcohol, or an alcohol and water.

14. The fuel cell according to claim 13, wherein the alcohol is methanol.

15. A fuel cell system, comprising the fuel cell according to claim 1.

16. A portable electronic device, which is driven by electricity generated by the fuel cell system according to claim 15.
